(19) United States
(12) Patent Application Publication
(10) Pub. No.: US 2012/0073089 A1
(43) Pub. Date: Mar. 29, 2012

(54) FASTENER HAVING A SELF-LOCKING ATTACHING DEVICE TO A VEHICLE BODY PART

(75) Inventor: Lara Buillas, Pontey (IT)

(73) Assignee: ILLINOIS TOOL WORKS INC., Glenview, IL (US)

(21) Appl. No.: 13/322,341

(22) PCT Filed: May 26, 2010
(86) PCT No.: PCT/US10/36164

§ 371 Date: Nov. 23, 2011

(30) Foreign Application Priority Data
May 26, 2009 (IT) TO2009A000398

(51) Int. Cl. F16B 21/02

(52) U.S. Cl. 24/293

(57) ABSTRACT

A fastener including: a shank designed to be throughly accommodated in use with a clearance in a slot of a body part; a hammer-like head which overhangingly extends from both sides of the shank, perpendicularly to a symmetric axis of the shank, insertable in use through the slot under the edge of the latter and oriented parallel to the slot; and an elastically deformable, suction-cap-shaped flange carried by the shank on the side opposite to the head, distanced from therefrom; a rotation of the shank to arrange the head perpendicularly to the slot makes it cooperate by interference under the edge of the slot with a consequent elastic deformation of the flange; the shank carries two elastically deformable oblique arms, which overhangingly extend from both sides of the shank, in a direction perpendicular to the head and so as to reciprocally move away from each other towards the flange, dimensioned so as to elastically cooperate against the shank when the head is introduced through the slot, and then stretch to snappingly engage the slot when the head is rotated.

### TECHNICAL FIELD

The present invention relates to a fastener of the type having at an end thereof an attaching device to a body part of a vehicle and at the opposite end a retaining device for a part or accessory to be attached to the vehicle body part. In particular, a fastener of this type is used to attach cables or tubes under the body or a finishing part to the frame of the vehicle body.

### BACKGROUND ART

It is known that in fasteners of the type described above the attaching device to the vehicle body part is generally of the bayonet type, and comprises, in particular, a hammer-shaped head, which overhangingly protrudes, from both sides, from an end of a shank of the fastener, at a predetermined distance from an elastically deformable generally suction-cap shaped flange, carried by the shank; in use, the head is introduced through a rectangular-shaped slot or perforation in the body part, arranging the head parallel to the slot, and thus the fastener with the shank engaged through the slot and the head arranged immediately underneath a peripheral edge of the slot is turned by 90° to arrange the head oriented perpendicularly, in order to take the latter to engage the peripheral edge of the slot, with consequent elastic deformation of the flange, which therefore works as elastic element, which maintains in tension the head/edge coupling of the slot.

Regretfully, in use, despite the presence of angular locking teeth obtained on the shank and despite the tension ensured by the elastic deformation of the flange with consequent generation of angular locking by friction, the fastener may be subjected to an accidental rotation which causes the head to be released from the slot, consequently putting the clip out of order. The accidental event may occur more frequently when a seal is arranged between the flange of the fastener and the body part to prevent dirt and humidity from reaching the slot and consequently penetrating inside the body part, which may be a box-like element of the body.

### DISCLOSURE OF INVENTION

It is an object of the present invention to overcome this drawback of the prior art by providing a clip of the type described above which, after having been installed, cannot undergo accidental rotations but remains locked in the assumed position because it is provided with a fastening lock of the self-locking type. This all, providing in all cases a fastener which is simple, reliable, not very large and relatively cost-effective.

The present invention thus relates to a fastener for a part or accessory to be secured to a vehicle body part, as disclosed in claim 1.

In particular, the fastener according to the present invention has an attaching device of the body part comprising: a shank designed to be throughly accommodated in use, with a clearance, in a slot of the body part; a hammer-like head shaped to be insertable in use through the slot immediately under an edge thereof, when the head is oriented parallel to the slot, the head being carried by a first end of the shank so as to overhangingly extend from both sides of the shank, perpendicularly to a symmetry axis of the shank; and an elastically deformable, suction-cap-shaped flange carried by the shank on the side opposite to the head, at a predetermined distance therefrom; wherein the head is adapted, upon a rotation in use of the shank which arranges it perpendicularly to the slot, to cooperate by interference under the edge of the slot with a consequent elastic deformation of the flange.

According to a feature of the invention, the shank carries two elastically deformable oblique arms, which overhangingly extend from both sides of the shank, in a direction perpendicular to the head and so as to reciprocally move away from each other towards the flange, the arms being dimensioned so as to cooperate in use with the edge of the slot to elastically deform against the shank when the head is introduced through the slot, and then stretch to snappingly engage the slot when the head is rotated perpendicularly to the slot.

In this manner, when the head is arranged perpendicularly to the slot, the elastic arms engage the slot in the sense of its longitudinal extension, thus preventing any further rotation of the shank in the slot, because the arms, following a possible minor rotation, touch the peripheral edge of the slot with the side flanks thereof and not in the longitudinal overhanging extension direction, therefore they cannot be deformed, in fact locking the head in the rotated position.

In particular, the elastically deformable arms have the shape of flat rectangular wings arranged, with respect to the shank, in an anchor-like configuration and have a maximum transversal dimension in a direction perpendicular to the overhangingly extension direction of the arms with respect to the shank, which maximum transversal dimension is only immediately smaller than the width of the slot.

The invention further relates to a system for securing a part or accessory of a vehicle to a vehicle body part using the aforesaid fastener according to claim 10.

### BRIEF DESCRIPTION OF THE DRAWINGS

Further features and advantages of the present invention will be apparent from the following description of a preferred embodiment thereof, exclusively provided by way of non-limitative example, with reference to the accompanying drawings, in which:

FIG. 1 shows an axonometric three-quarters front view from the bottom of a fastener made according to the invention;

FIGS. 2 and 3 show in enlarged scale respective orthogonal elevation views of an attaching device of the fastener to a vehicle body part, the rest of the fastener being only diagrammatically shown by a dash-and-dotted line; and

FIGS. 4, 5 and 6 show respective elevated views of the attaching device of the fastener in various configurations of use assumable during its coupling with the body element, shown diagrammatically in section; and

FIGS. 7 and 8 show two plan views from the bottom of the attaching device of the fastener in the configurations of FIGS. 4 and 6 respectively and of the body part with which it couples, shown with a dashed line.

### BEST MODE FOR CARRYING OUT THE INVENTION

With reference to figures from 1 to 8, numeral 1 indicates as a whole a fastener for a part or accessory (known and not shown for the sake of simplicity) to be secured to a vehicle body part 2. The fastener 1 comprises at a first end thereof an attaching device 4 to the body part 2, which is the specific object of the present invention, and, on a second end thereof, opposite to the first, a retaining device 5, of known type, for the part or accessory, in the non-limiting example shown consisting of a rack-shaped claw for tubes or cables, or, alternatively, for example, of a female screw (known and not shown). In figures from 2 to 8, being of any type, the retaining device 5 is replaced by a block shown by dash-and-dotted line.

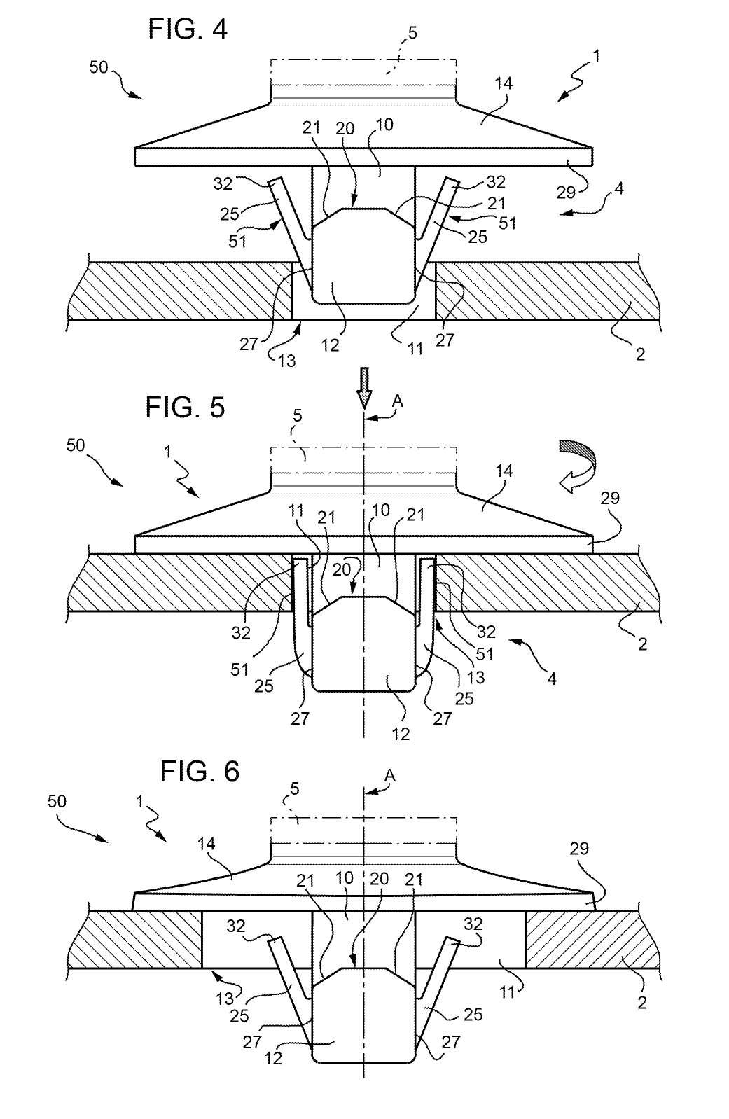

The attaching device 4 comprises a shank 10 which can be throughly accommodated in use with clearance in a slot 11 of the body part 2, a hammer-like head 12 shaped to be insertable in use through the slot 11 immediately under an edge 13 thereof, when the head 12 is oriented parallel to the slot 11 (FIGS. 4, 5 and 7) and an elastically deformable, suction-cap-shaped flange 14 carried by the shank 10 on the side opposite to the head 12, in the case in point a part of the retaining device 5, immediately under it, at a predetermined distance from the head 12.

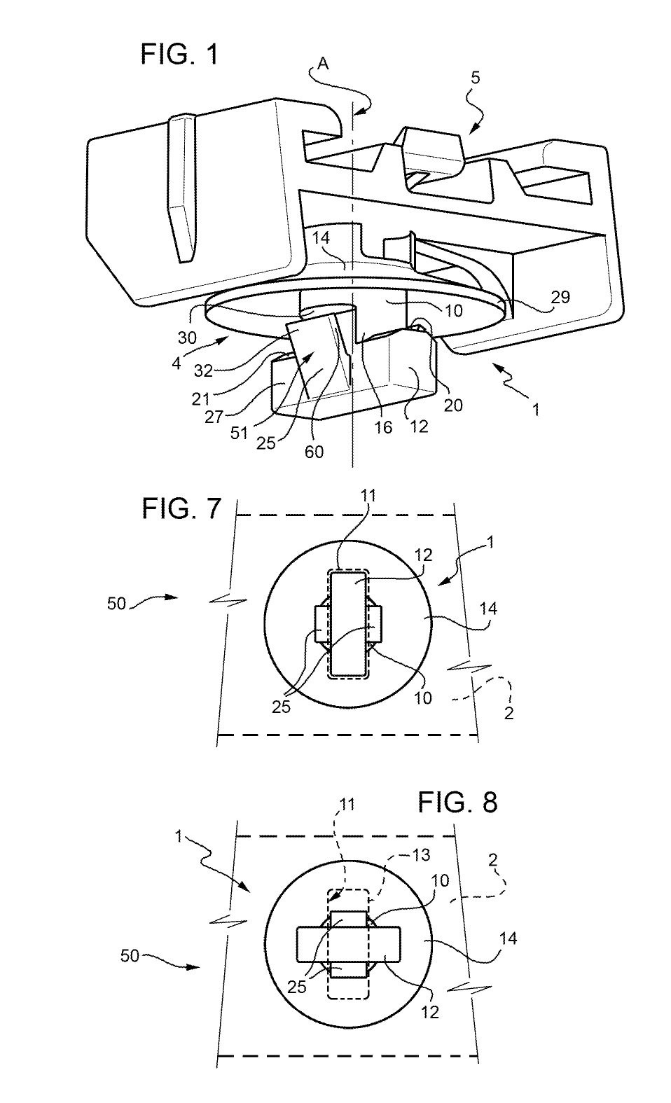

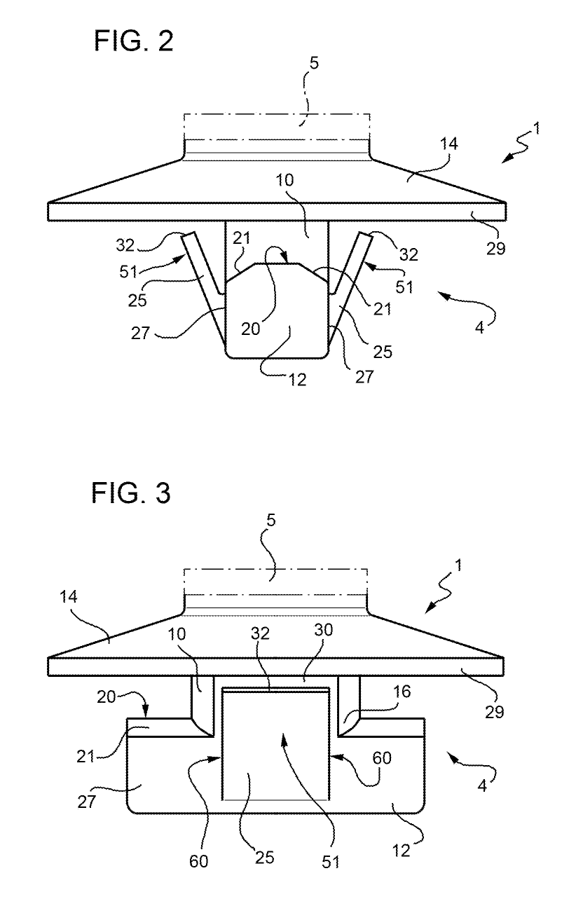

In particular, the head 12 is carried by a first end 16 (FIGS. 1 and 3) of the shank 10, opposite to the retaining device 5, so as to overhangingly extend from both sides of the shank 10, perpendicularly to a symmetry axis A of the shank 10, which is cylindrical in the illustrated case in point.

Because of its arrangement and T-shaped arrangement with respect to the shank 10, the head 12 is adapted as a consequence of a rotation in use of the shank 10 which arranges the head 12 perpendicularly to the slot 11 (FIGS. 6 and 8), instead of parallel thereto, to cooperate by interference under the edge 13 of the slot 11 with consequent elastic deformation of the flange 14.

On the basis of the description, the head 12 is therefore adapted to assume as a consequence of a rotation of the shank 10 in the slot 11, a first introduction configuration (FIGS. 4, 5, 7), in which it is oriented parallel to the slot 11, and a second locking configuration (FIGS. 6, 8), in which the head 12 is oriented perpendicularly to the slot 11 and cooperates by interference under the edge 13 of the slot 11 with consequent elastic deformation of the flange 14, which thus applies on the head 12 a consequent tension along axis A which presses, in use, an upper face 20 of the head 12 against the body part 2 and, in particular, against the rear part of the edge 13 of the slot 12.

In order to allow the head 12 to more easily reach the locking configuration, starting from the introduction configuration, after a 90° rotation, either clockwise or counterclockwise, of the shank 10, the face 20, which is facing the flange 14, is provided with inclined plane means 21 (of known type) adapted to intercept in use the edge 13 of the slot 11 as a consequence of the rotation of the hammer-shaped head 12 with respect to an introduction direction of the head 12 itself in the slot 11, wherein the hammer-shaped head 12 and slot 11 are arranged parallel to one another.

According to the main aspect of the invention, in combination with what described above, the attaching device 4 is made so as to be self-locking in the locking configuration of the head 12.

For this purpose, the shank 10 carries two elastically deformable oblique arms, which overhangingly extend from both sides of the shank 10, in a direction perpendicular to the head 12 and so as to reciprocally move away from each other towards the flange 14. The arms 25 being dimensioned so as to cooperate in use in the introduction configuration of the head 12 with the edge 13 of the slot 11 (FIG. 5) to elastically be deformed against the shank 10 when the head 12 is introduced through the slot 11, and then stretch to snappingly engage the slot 11 (FIGS. 6 and 8) when the head 12 is rotated perpendicularly to the slot 11.

A hammer-shaped head 12 has the same shape of the slot 11 in plan view and has a maximum longitudinal extension in a first direction perpendicular to the symmetric axis A of the shank 10; and a maximum transversal extension in a second direction perpendicular to the symmetric axis A of the shank 10 and perpendicular to the first extension.

Such maximum longitudinal and transversal extensions are only slightly smaller than the maximum longitudinal and transversal extension, respectively, of the slot 11, which is rectangular-shape in plan view in the illustrated case in point.

The elastically deformable arms 25 extends transversally and overhangingly with respect to the shank 10 in the mentioned second direction perpendicular to the symmetry axis A, starting from opposite side flanks 27 of the head 12, and towards the flange 14.

Furthermore, the elastically deformable arms 25 overhangingly extend, in length, close to a peripheral edge 29 of the flange 14 and at a predetermined distance from the shank 10; the latter is provided on the side of the side flanks 27 of the head 12 and at the flange 14 with respective recesses 30 (FIG. 1) for abuttingly receiving in use respective free ends 32 of the arms 25 when the latter are in the deformed condition, shown in FIG. 5.

The elastically deformable arms 25 preferably have the shape of flat rectangular wings arranged, with respect to the shank 10, in an anchor-like configuration; and have a maximum transversal dimension in a direction perpendicular to the overhanging extension direction of the arms 12 themselves with respect to the shank 10, which maximum transversal dimension is only just smaller than the width of the slot (FIG. 8).

By virtue of the described structure, the fastener 1 is made in one piece in a molded synthetic plastic material, and is therefore cost-effective to make.

According to the description, the fastener 1 thus belongs to a securing system, indicated as a whole by numeral 50 (FIGS. 4-8), of a vehicle part or accessory (known and not shown) to a body part 2, further comprising the slot 11 obtained through the body part 2, in addition to the fastener 1.

In use, the fastener 1 faces the slot 11, with the head 12 arranged parallel to the latter and in axis with the same and then by exerting a push in the direction of axis A (arrow in FIG. 5) the head 12 is introduced through the slot 11, until the inclined plane means 21 go beyond the edge 13, positioning themselves behind the same; such an introduction stress further elastically deforms the flange 14, allowing the head 12 to go beyond the edge 13, under the same.

During such introduction movement, the arms 25, with the respective oblique lower faces 51 thereof (FIGS. 4 and 5) collide against the edge 13 and are consequently bent towards the shank 10, so as to reduce the spreading thereof, until it is cancelled (arms 25 arranged parallel to the shank 10, with the ends 32 abutting against the recesses 30—FIG. 5).

In these conditions, they enter in the slot 11 by virtue of the side clearance which exists between the edge 13 and the shank 10 that they occupy nearly entirely with their thickness.

Subsequently, by maintaining the axial trust in the sense of the arrow, the operator in charge of assembly turns the fastener 1 by 90° in the direction of the arrow (FIG. 5) to take the head 12 to the configuration shown in FIGS. 6 and 8, oriented perpendicularly to the slot 11.

During such a movement, the oblique arms 25 pass from an orientation transversal to the slot 11 (FIGS. 4 and 5) to an orientation parallel to the slot 11 (FIG. 6), in which the faces 51 stop cooperating with the edge 13 and the arms 25 are free to extend in the maximum spreading position, occupying most of the length of the slot 11.

In such a configuration, respective side edges 60 of the arms 25 (FIGS. 1 and 3) are arranged parallel and adjacent to longitudinal sides of the edge 13 and the arms 25 nearly integrally occupy the entire width of the slot 11; in this manner, any further rotation of the shank 10 in the slot 11 is prevented because any attempt to rotate the shank 10 makes the edges or sides 60 intercept the edge 13, blocking the rotation itself, the arms 25 not being flexible in the direction of longitudinal extension of the head 12, direction in which the edges 60 are indeed oriented, but only in the transversal direction of extension of the head 12, direction in which the faces 51 are oriented on the other hand.

Once installed, the attaching device 4 is consequently self-locking and no longer allows the fastener 1 to be released at all from the body parts 2, unless obviously the arms 25 are broken, operation which can only be carried out intentionally by an operator who wants to disassemble the fastener 1.

1. A fastener for an accessory part or element to be secured to a vehicle body part, the fastener comprising at a first end thereof an attaching device to the body part, comprising: a shank designed to be throughly accommodated in use with a clearance in a slot of the body part; a hammer-like head shaped to be insertable in use through the slot immediately under an edge thereof, when the head is oriented parallelly to the slot, the head being carried by a first end of the shank so as to overhangingly extend from both sides of the shank, perpendicularly to a symmetry axis of the shank; and an elastically deformable, suction-cap-shaped flange carried by the shank on the side opposite to the head, at a predetermined distance therefrom; wherein the head is adapted, upon a rotation in use of the shank which arranges it perpendicularly to the slot, to cooperate by interference under the edge of the slot with a consequent elastic deformation of the flange, characterized in that the shank carries two elastically deformable oblique arms, which overhangingly extend from both sides of the shank, in a direction perpendicular to the head and so as to reciprocally move away from each other towards the flange, the arms being dimensioned so as to cooperate in use with the edge of the slot to elastically deform against the shank when the head is introduced through the slot, and then stretch to snappingly engage the slot when the head is rotated perpendicularly to the slot.

2. A fastener according to claim 1, characterized in that the hammer-like head has the same shape as the slot in plan; and has a maximum longitudinal extension in a first direction perpendicular to the symmetry axis of the shank; and a maximum transversal extension in a second direction perpendicular to the symmetry axis of the shank and perpendicular to the first extension.

3. A fastener according to claim 2, characterized in that said maximum longitudinal extension is only immediately smaller than the longitudinal extension of the slot; while said maximum transversal extension is only immediately smaller than the transversal extension of the slot.

4. A fastener according to claim 2, characterized in that said elastically deformable arms transversally and overhangingly extend with respect to the shank in said second direction perpendicular to the symmetry axis, from opposite side flanks of said hammer-like head and towards said flange.

5. A fastener according to claim 4, characterized in that said elastically deformable arms overhangingly extend, in length, close to a peripheral edge of said flange and at a predetermined distance from said shank; and in that on the side of said side flanks of the hammer-like head, said shank is provided with respective recesses for abuttingly receiving in use respective free ends of the arms when the latter are in the deformed condition.

6. A fastener according to claim 1, characterized in that said elastically deformable arms have the shape of flat rectangular wings arranged, with respect to said shank, in an anchor-like configuration; and in that they have a maximum transversal dimension in a direction perpendicular to the overhangingly extension direction of the arms with respect to the shank, which maximum transversal dimension is only immediately smaller than the width of said slot.

7. A fastener according to one of the claim 1, characterized in that said hammer-like head is provided, at a first face thereof facing in use the flange, with inclined-plane means adapted to intercept in use the edge of the slot in response to a rotation of the hammer-like head with respect to a direction of introduction of the hammer-like head in the slot, in which the hammer-like head and the slot are arranged parallel to each other.

8. A fastener according to claim 1, characterized in that it comprises, at a second end thereof opposite to the first, a retaining device for said accessory part or element.

9. A fastener according to claim 1, characterized in that it is made in a one piece of molded synthetic plastic material.

10. A system for securing an accessory vehicle part or element to a vehicle body part, comprising a slot thoroughly obtained through the body part and a fastener provided, at a first end thereof, with an attaching device to the body part and, at a second end opposite to the first, with a retaining device for the accessory part or element; wherein the attaching device comprises a shank thoroughly accommodated with a clearance through the slot; a hammer-like head shaped so as to be able to be inserted through the slot up to immediately under an edge thereof, the head being carried by a first end of the shank so as to overhangingly extend from both sides of the shank, perpendicularly to a symmetry axis of the shank; and an elastically deformable, suction-cap-shaped flange carried by the shank on the side opposite to the head, at a predetermined distance therefrom; the head being designed to be arranged, in response to a rotation of the shank in the slot, in a first, introduction configuration, in which it is oriented parallelly to the slot, and in a second, locking configuration, in which the head is oriented perpendicularly to the slot and cooperates by interference under the edge of the slot with a consequent elastic deformation of the flange; characterized in that the shank carries two oblique, elastically deformable arms which overhangingly extend from both sides of the shank, in a direction perpendicular to the head and so as to move away from each other towards the flange, the arms being dimensioned so as to cooperate in use with the edge of the slot to be elastically deformed against the shank in the introduction configuration of the head in the slot, and then stretch to snappingly engage the slot when the head takes the locking configuration, so as to prevent any further relative rotation of the shank in the slot.
